(19) United States
(12) Patent Application Publication
(10) Pub. No.: US 2014/0004963 A1
(43) Pub. Date: Jan. 2, 2014

(54) TELESCOPIC UNIVERSAL JOINT

(71) Applicants: HONG FU JIN PRECISION INDUSTRY (SHENZHEN) CO., L, Shenzhen (CN); HON HAI PRECISION INDUSTRY CO., LTD., New Taipei (TW)

(72) Inventor: LI-SHI ZHOU, Shenzhen (CN)

(73) Assignees: HON HAI PRECISION INDUSTRY CO., LTD., New Taipei (TW); HONG FU JIN PRECISION INDUSTRY (ShenZhen) Co., LTD, Shenzhen (CN)

(21) Appl. No.: 13/688,845

(22) Filed: Nov. 29, 2012

(30) Foreign Application Priority Data
Jun. 27, 2012 (CN) 2012102149539

(51) Int. Cl. F16C 1/04

(52) U.S. Cl. CPC F16C 1/04
USPC 464/155

(57) ABSTRACT

A telescopic universal joint includes a first joint and a second joint. A sleeve is connected to the second joint. A sliding member includes one end connected to the first joint, and is slidably received in the sleeve. A resilient ring is snugly arranged around the sliding member, and stays in a tight contact with an inner surface of the sleeve, thereby creating a friction between the resilient ring and the inner surface and allowing the sliding member to be positioned at a desired position by the friction.

### BACKGROUND

1. Technical Field

The present disclosure relates to a telescopic universal joint.

2. Description of Related Art

Universally jointed drive lines are often used to transmit a torque from a power source to a load which is movable with respect to the power source. Because they are able to pivot or flex, while transmitting torque, universal joints are able to accommodate a variety of movements. However, in many cases, relative movements between the source and load require length changes as well as pivotal or angular movements in the drive line. These length changes have long been accommodated by sliding splined connections and the like at some point in the drive line. More recently, universal joints have been designed which permit relative axial movement between their driving and driven members, thus, in some cases, avoiding the need for sliding splined connections.

Although some such conventional universal joints can satisfy basic requirements, it is still useful to provide a new telescopic universal joint.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of one embodiment of a telescopic universal joint.

FIG. 2 is an isometric exploded view of the telescopic universal joint of FIG. 1.

FIG. 3 is a cross-sectional view of the telescopic universal joint, taken along line of FIG. 1.

### DETAILED DESCRIPTION

Embodiments of the present disclosure will be described with reference to the accompanying drawings.

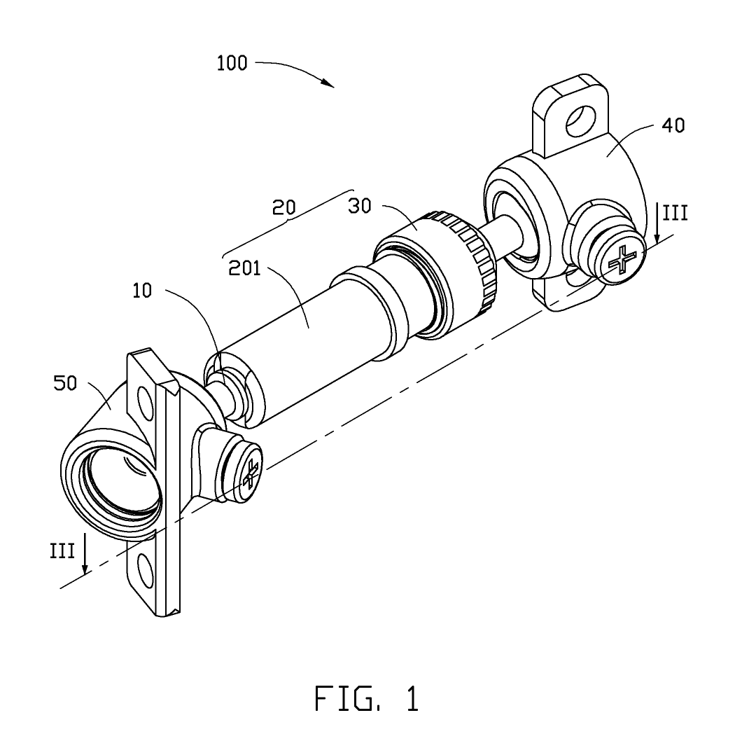

Referring to FIG. 1, one embodiment of a telescopic universal joint 100 is shown. The telescopic universal joint 100 includes a sliding member 10 and a sleeve 20. The sleeve member 20 includes a hollow sleeve body 201 and a cap 30. A first joint 40 is connected to an end 101 of the sliding member 10, and a second joint 50 is connected to the sleeve body 201 of the sleeve 20.

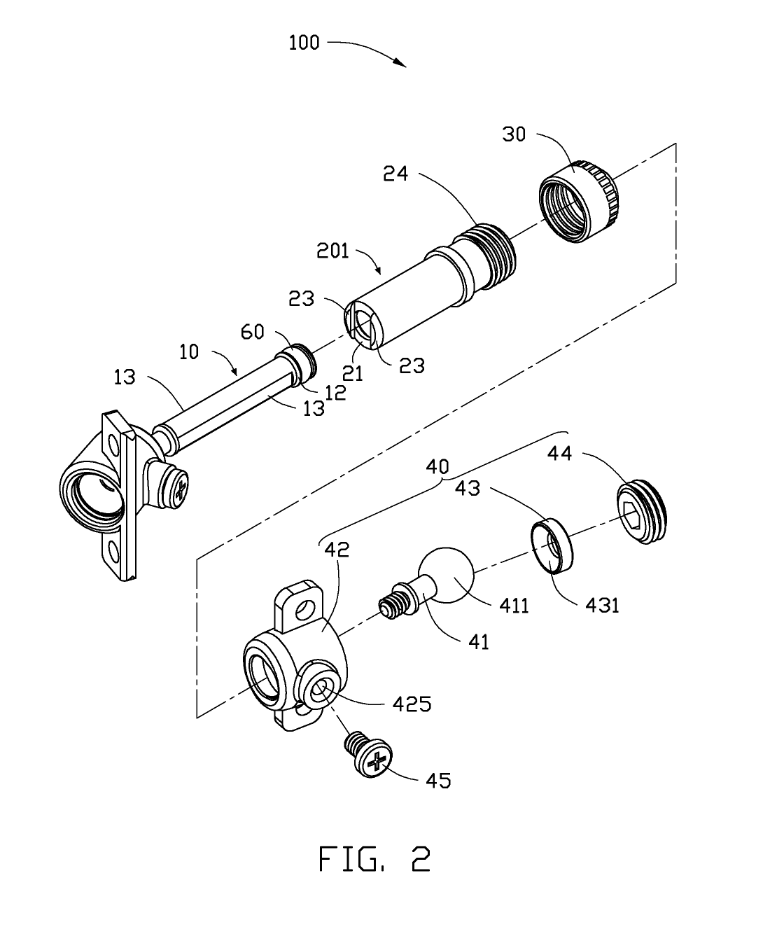

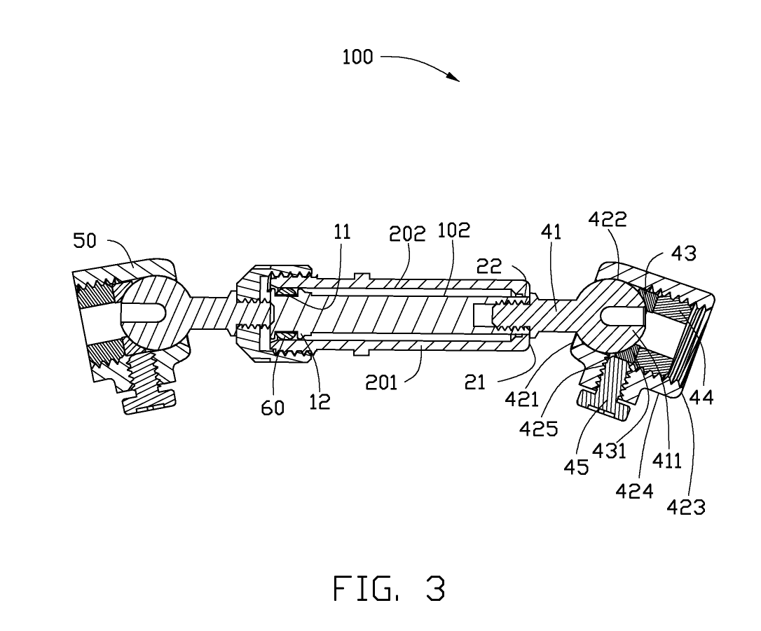

Referring to FIGS. 2 and 3, the sliding member 10 is substantially cylindrical and is slidably received in the hollow sleeve body 201. A resilient ring 60 is snugly arranged around the sliding member 10. In the embodiment, the sliding member 10 defines an annular slot 11 in its lateral surface 102, and the resilient ring 60 is securely located in the slot 11. The resilient ring 60 stays in a tight contact with an inner surface 202 of the sleeve body 201. The friction between the resilient ring 60 and the inner surface 202 can position the sliding member 10 at any desired position.

In the embodiment, the sliding member 10 includes a flange 12 on the lateral surface 102. The flange 12 will contact an inward projection 22 formed at an end 21 of the sleeve body 201, thereby preventing the sliding member 10 from sliding out of the sleeve body 201.

The sleeve body 201 further includes two protruding portions 23 on the end 21 of the sleeve body 201. The sliding member 10 further includes two planar surfaces 13 extending along its lengthwise direction. The two planar surfaces 13 face the two protruding portions 23, respectively. The two planar surfaces 13 contacting the two protruding portions 23 can prevent the sliding member 10 from rotating with respect to the sleeve body 201.

The cap 30 is a hollow cylinder and includes internal thread engaging the external thread formed at an end 24 of the sleeve body 201, thereby connecting the cap 30 to the sleeve body 201.

The first joint 40 and the second joint 50 have substantially the same construction and therefore the following description of the first joint 40 also applies to the second joint 50.

The first joint 40 includes a stud 41 and a ball seat 42. The stud 41 is connected to the sliding member 10. A ball 411 is formed on one end of the stud 41, and is pivotally received in the ball seat 42. In the embodiment, the inner surface adjacent to one end 421 of the ball seat 42 includes an arc-shaped portion 422. The ball 411 contacts the arc-shaped portion 422. The inner surface adjacent to another end 423 of the ball seat 42 defines a thread to engage a screw 44. The arc-shaped portion 422 and the screw 44 cooperatively prevent the ball 411 from disengaging from the ball seat 42.

The first joint 40 further includes a friction pad 43 that includes a first end abutting against the screw 44, and a second end including an arc-shaped surface 431 abutting against the ball 411. The friction pad 43 is made of resilient material and stays in tight contact with the ball 411. The friction between the ball 411 and the friction pad 43 can position the ball 411 at any desired position.

In one embodiment, the ball seat 42 defines a threaded hole 425 in its lateral surface 424. An adjusting screw 45 is screwed into the threaded hole 425 and used to push the friction pad 43. A user can turn the adjusting screw 45 to push the friction pad 43, causing the friction pad 43 to stay in tight contact with the ball 411. Thus, the friction pad 43 can provide sufficient friction to position the ball 411.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. A telescopic universal joint comprising:
a first joint;
a second joint;
a sleeve connected to the second joint;
a sliding member comprising one end connected to the first joint, the sliding member being slidably received in the sleeve;
a resilient ring snugly arranged around the sliding member, the resilient ring staying in a tight contact with an inner surface of the sleeve, thereby creating a friction between the resilient ring and the inner surface and allowing the sliding member to be positioned at a desired position by the friction.

2. The telescopic universal joint according to claim 1, wherein the sliding member defines an annular slot in a lateral surface thereof, and the resilient ring is located in the annular slot.

3. The telescopic universal joint according to claim 1, wherein the first joint and the second joint have the same construction.

4. The telescopic universal joint according to claim 1, wherein the first joint comprises a stud supporting a ball and a ball seat pivotally receiving the ball therein, and the one end of the sliding member is connected to the stud.

5. The telescopic universal joint according to claim 4, wherein the first joint further comprises a friction pad received in the ball seat, and the friction pad stays in tight contact with the ball thereby creating a friction between the friction pad and the ball and allowing the ball to be positioned at a needed position.

6. The telescopic universal joint according to claim 5, wherein the first joint further an adjusting screw screwed into a threaded hole of the ball seat, and the adjusting screw is configured to apply a push force to the friction pad, causing the friction pad and the ball to stay in tight contact with each other.
